(19) United States
(12) Patent Application Publication
(10) Pub. No.: US 2021/0368069 A1
(43) Pub. Date: Nov. 25, 2021

(54) COLOR TABLES

(71) Applicant: HEWLETT-PACKARD DEVELOPMENT COMPANY, L.P., Spring, TX (US)

(72) Inventors: Morgan T Schramm, Vancouver, WA (US); Ranjit Bhaskar, Vancouver, WA (US)

(21) Appl. No.: 16/609,480

(22) PCT Filed: May 15, 2018
(86) PCT No.: PCT/US2018/032807

§ 371 Date: Oct. 30, 2019

(51) Int. Cl. H04N 1/60

(52) U.S. Cl. CPC H04N 1/6019; H04N 1/6008; H04N 1/6058; H04N 1/603

(57) ABSTRACT

A color table is modulated. The color table includes nodes that correspond with a color input in a first color space and provides a print substance formulation in a second color space. For a set of the nodes, a determination is made as to whether a color amount based on the print substance formulation is outside of threshold value. For each node in which the color amount for the node is outside the threshold value, the print substance formulation is replaced with a replacement print substance formulation having a color amount that is within the threshold value.

### BACKGROUND

Color management systems deliver a controlled conversion between color representations of various devices, such as image scanners, digital cameras, computer monitors, printers, and corresponding media. Device profiles provide color management systems with information to convert color data between color spaces such as between native device color spaces and device-independent color spaces, between device-independent color spaces and native device color spaces, and between source device color spaces and directly to target device color spaces.

### BRIEF DESCRIPTION OF THE DRAWINGS

FIG. 1 is a block diagram illustrating an example method.

FIG. 2 is a block diagram illustrating an example method to modulate a color table according to the method of FIG. 1.

FIG. 3 is a block diagram illustrating example models generated according to the example methods of FIGS. 1 and 2.

FIG. 4 is a block diagram illustrating an example system to implement the example methods of FIGS. 1 and 2 and produce an example target color table.

### DETAILED DESCRIPTION

A color space is a system having axes and that describes color numerically. Some output devices, such as printing devices, may employ a type of subtractive color space, which can include a type of cyan-magenta-yellow-key (black) (CMYK) color space, while some software applications and display devices may employ a type of additive color space, which can include a type of red-green-blue (RGB) color space. For example, a color represented in an RGB color space has a red channel value, a green channel value, and a blue channel value, and a color represented in a CMYK color space has a cyan channel value, a magenta channel value, a yellow channel value, and a black or key channel value, that combined numerically represent the color. A color gamut for a device is a property of the device that includes the range of color (and density/tonal values) that the device can produce as represented by a color space. As used in this disclosure, a process color component includes the cyan, magenta, and yellow channels in the subtractive color space and does not include the black channel in the subtractive color space.

A color management resource is a set of data based on the color gamut characterization in a color space. A color profile is an example of a color management resource. A color profile is a formal set of data that characterizes the color gamut in a color space. In one example, a color profile can describe the color attributes of a particular device or viewing specifications with a mapping between the device-dependent color space, such as a source or target color space, and a device-independent color space, such as profile connection space (PCS), and vice versa. The mappings may be specified using tables such as look up tables, to which interpolation can be applied, or through a series of parameters for transformations. Devices and software programs—including printing devices, monitors, televisions, and operating systems—that capture or display color can include color profiles that comprise various combinations of hardware and programming. An ICC profile is an example color profile that is a set of data that characterizes a color space according to standards promulgated by the International Color Consortium (ICC). Examples of this disclosure using particular profiles, such as ICC profiles, however, are for illustration only, and the description is applicable to other types of color profiles, color management resources, or color spaces.

The ICC profile framework has been used as a standard to communicate and interchange between various color spaces. An ICC output profile includes color table pairs, so-called A2B and B2A color look up tables, where A and B denote the device-dependent and the device-independent color spaces, respectively. For different devices, there are different look up table rendering intent pairs. For example, an ICC profile allows for three color table pairs, enumerated from 0 to 2, enabling the user to choose from one of the three possible rendering intents: perceptual, colorimetric, or saturation. ICC profiles are often embedded in color documents as various combinations of hardware and programming to achieve color fidelity between different devices. The size of color tables will increase with finer sampling of the spaces and larger bit depths.

Color tables that provide transformations between various color spaces are extensively used in color management, common examples being the transformations from device independent color spaces (such as CIELAB, i.e., L*a*b*) to device dependent color spaces (such as RGB or CMYK) and vice versa. The mappings may be specified using tables such as single dimensional or multidimensional look-up tables, to which interpolation can be applied, or through a series of parameters for transformations. A color table can include an array or other data structure stored on a memory device that replaces runtime computations with a simpler array indexing operation as a color look-up table. Color tables can also include monochromatic and greyscale color tables. In a greyscale table, for example, the value corresponding to a source color space such as RGB can be of luminous intensity.

Printing devices, including printing devices that print in color mode and printing devices that print in black and white or monochromatic mode, employ color management systems including color management resources to deliver a controlled conversion between color representations of various devices, such as image scanners, digital cameras, computer monitors, printers, and software applications including operating systems, browsers, and photo and design programs often to a subtractive color space or a monochromatic color space such as greyscale. In general, printing devices apply a print substance, which can include printing agents or colorants often in a subtractive color space or black, to a medium via a device component generally referred to as a print head. A medium can include various types of print media, such as plain paper, photo paper, polymeric substrates and can include any suitable object or materials to which a print substance from a printing device are applied including materials, such as powdered build materials, for forming three-dimensional articles. Print substances, such as printing agents, marking agents, and colorants, can include toner, liquid inks, or other suitable marking material that may or may not be mixed with fusing agents, detailing agents, or other materials and can be applied to the medium.

Printing devices often employ color tables to provide transformations between input color spaces and subtractive color spaces to determine corresponding formulations of print substance amounts, such as print substance volumes, to render the intended colors. In one example, printing devices often employ color tables including multidimensional color look-up tables to provide transformations between different color spaces such as from input device-independent colors to CMYK print substance amounts in the case of two-dimensional printing devices for printing on substrates or, in the case of three-dimensional printing devices, printing agent amounts for printing on a powder or other material. Many colors in the gamut of a CMYK color space for printing devices can be rendered from just the set of process colors of cyan, magenta, and yellow and, in some color resource models, do not include a black channel component. In many printing devices and printing modes, however, an achromatic black channel component can be added to some of colors in in the CMYK color space order to reduce process color print substance consumption for some darker colors, stabilize neutral color such as in the grey tones, and to improve printability of blacks.

For printing devices, color management resources including the color tables can be embedded in memory devices storing the printer firmware or other hardware such as a controller. In some examples, the particular color transform of the color management resource may be colorant-dependent, such as dependent on the particular formulation of each of the print substance included in a supply component such as a print substance cartridge, and information regarding the color gamut characterization in the color management resource can be stored on a memory device located on the cartridge for use with the printing device such as its firmware or other hardware.

In one example, a color management resource for a printing device may include a plurality of multidimensional color tables that can correspond to media, rendering intents, and colorant axes of a color gamut, among other things, included in a color profile. In general, a profile can include N color tables to be processed, such as CLUT₁, CLUT₂, . . . , CLUT_{N}, and the input color space includes Jᵢₙ channels. In one example, multiple color tables representing different rendering intents can be included with one ICC profile. Additionally, the output color space includes Jₒᵤₜ channels, and in many examples of an ICC profile Jᵢₙ and Jₒᵤₜ can be 3 or 4 channels. For each output channel, the corresponding lookup table contains M^{J}^{ᵢₙ} nodes. For example, each color table can include M⁴ nodes for each of the cyan, magenta, yellow, and black colorants corresponding with each print substance color used in the printing device or M³ nodes for each of the red, green, and blue three additive primaries corresponding with each primary color used in the display device.

As an example used for illustration in this disclosure, a color table to convert an input value in an RGB color space to an output value representing a print substance formulation in a CMYK space may include 17³ nodes, or 4913 nodes. In one example, each color in the example RGB color space may be represented as an eight bits per channel input. In one sample provided for a color table, each channel can have an eight bit input value selected from the set of seventeen input values including 0x00, 0x10, 0x20 . . . 0xE0, 0xF0, and 0xFF. For instance, the input 0x0000FF may represent blue in the example RGB color space, the input 0x00FFFF may represent cyan or aqua blue in the example RGB color space, and the input 0x000080 may represent navy blue in the example RGB color space. The color table maps the inputs in the RGB color space to eight, ten, or twelve bit values per channel in the CMYK color space that can correspond with a print substance formulation based on a selected printer dots per inch (dpi) cell, such as 300 dpi, for a drop weight of a pen and the print mode. In an example of an eight bit per channel CMYK color space output, a color table may receive a twenty-four bit input from the RGB color space and produce an thirty-two bit output representing a print substance formulation in the CMYK color space as follows:

| Node No. | RGB Input | | CMYK Output |
|---|---|---|---|
| 1 | 0x000000 | −> | 0x000000C8 |
| 2 | 0x000010 | −> | 0x131000B4 |
| 3 | 0x000020 | −> | 0x161300A7 |
| . | . | | . |
| . | . | | . |
| . | . | | . |
| 4912 | 0xFFFFF0 | −> | 0x00001D00 |
| 4913 | 0xFFFFFF | −> | 0x00000000 |

Thus, the example color in the RGB color space having an input value of 0x000020 into the color table, which corresponds with a red channel value of 0x00, a green channel value of 0x00, and a blue channel value of 0x20, would be converted to a print substance formulation in the CMYK color space having a cyan print substance formulation with a value of 0x16, a magenta print substance formulation with a value of 0x13, a yellow print substance formulation with a value of 0x00, and a black print substance formulation with a value of 0xA7. In the example color table, the nodes are indexed from 1 to M^{J}^{ᵢₙ} by order of increasing input value, but the color table may be indexed via other criteria.

Often, a color gamut for the input color space will include more than M^{J}^{ᵢₙ} colors. In the present example, the color gamut for a printing device often includes more than 4913 colors, and print substance formulations for certain input colors are not be found in the color table. For example, the input value 0x4169E1 may represent royal blue in the example RGB color space, but would not correspond with a node in the color table and thus would not map to a print substance formulation in the table. The example royal blue would appear between nodes having input values 0x4060E0 and 0x5070F0 and may be considered an intermediate color. Print substance formulations for such intermediate colors can be determined via interpolation using nodes in the color table with firmware for the printing device.

The print substance formulations in the color table can affect the cost of printing. Typically, cyan, magenta, and yellow print substances are significantly more expensive than similar amounts of black print substances, and printing with process color print substances is typically significantly more expensive than printing with just black print substance. Additionally, the more print substance amounts included in print substance formulation produces a more vibrant image on a medium, and color tables optimized for image quality may include print substance formulations having significant volumes of print substance amounts. Some users may attempt to reduce the cost of printing by printing some color image sources as documents in greyscale mode, or black and white mode, while selectively printing documents in full color mode or by printing all documents in black and white mode. Often, black and white mode versions of color sources lack significant information or distinctions that users may find valuable.

Other users may attempt to address the additional expense by printing color documents in a depleted color mode with depleted colors that compromise print quality. But modulating printing cost via a color table while maintaining the visual appeal of the printed image may present challenges. In a typical example of a depleted color mode, the amount of the color printing agent or colorant is uniformly scaled back from an amount used in full color mode to produce a washed out depiction of the source document. For example, the print substance amounts in a print substance formulation may be uniformly scaled down by a selected percentage such as a twenty percent per amount of print substance. As many colors do not include a black component in the CMYK color space, such as pastels, such colors become depleted to almost white. While uniform color depletion outputs may convey more information than black and white mode and save on expense over a full color mode, such color depletion outputs typically include poor image quality that many users find unappealing at meaningful reductions of printing cost.

The disclosure includes a method that can reduce the cost of printing via modulating the print substance formulation of a color table. In the examples, the print substance formulation of the nodes in the color table, which can include the amounts of each print substance used in the print substance formulation, is used as a proxy for cost. In one example, the nodes are assigned a cost based on the print substance formulation. The print substance formulations for nodes that exceed a threshold cost are replaced with a replacement print substance formulation that is within the threshold. The threshold cost can be selected based on the amount of cost saving desired.

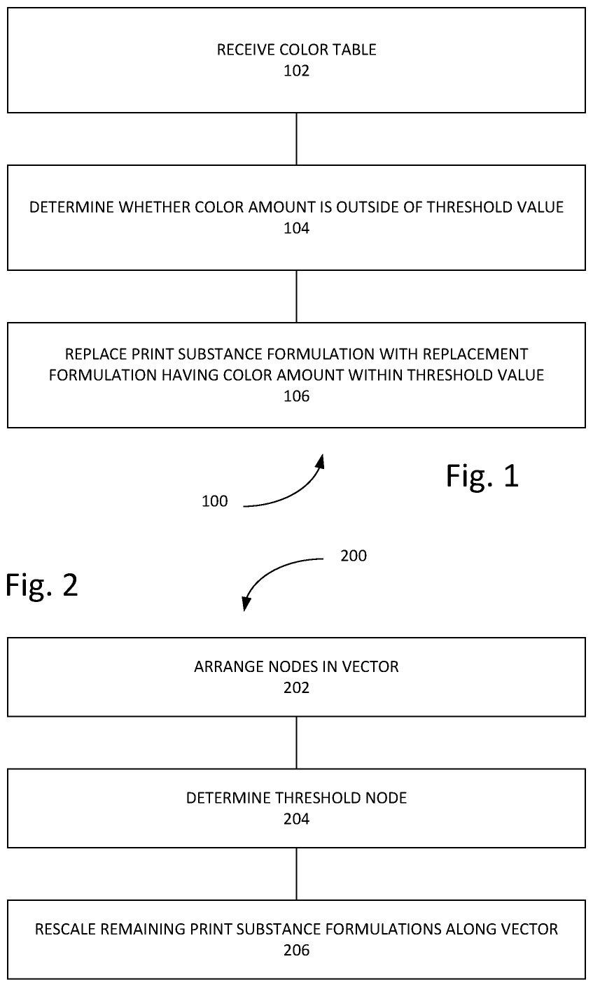

FIG. 1 illustrates an example method 100 for creating a target color table having a modulated print substance formulation, such as print substance formulation modulated based on the cost of the print substances, from a source color table. In the example, the color table can be used to map a source color from a first color space to a target color in a second color space and stored on a memory device for use with a printing device. The first color space may be different than the second color space, and, in one example, the second color space may be a device dependent color space and can include a subtractive color space of a printing device. For instance, the printing device may employ a CMYK color space corresponding with process colors of cyan, magenta, and yellow print substances and a black print substance. In the example method 100, a color table to be modulated is received at 102. The color table includes a plurality of nodes, and each node corresponds with a color input in the first color space and provides a print substance formulation in the second color space. A determination as to whether a color amount of a set of nodes of the plurality of nodes is outside of a threshold value based on the color substance formulation at 104. The color amount can be determined for each node of the color table or for a subset of the nodes of the color table. In one example, the determination is made for each node of the plurality of nodes. The color amount can include an amount of print substance used in print substance formulation. An example of color amount outside of a threshold value is a color amount that exceeds the threshold value. For each node in which the determined color amount for the node is outside the threshold value, the print substance formulation is replaced with a replacement print substance formulation having color amount that is within, or not outside, the threshold value at 106. In one example, a color amount within the threshold value can include a color amount generally equal to the threshold value. The nodes of the color table can be maintained, but the print substance formulation for a subset of the plurality of nodes is modulated.

The color amount is based on the print substance formulation at 104. In one example, the color amount can include the amount of some or all of the print substances used in the print substance formulation, such as the volume of print substances. In another example, the color amount can include the cost to produce the target color. For instance, the cost of the target color can be determined from the amount and cost of the print substances in the print substance formulation used to produce the target color. In one example, the actual cost of all print substances used to produce the target is color is summed to provide the color amount. In another example, the amount of the print substances in the print substance formulation is used as a proxy for price. In one instance, just the amounts of the print substances for the process colors in the print substance formulation are summed to determine the color amount. In another instance, the amount of black print substance is multiplied by a selected coefficient and is added to the amounts of the print substances for the process colors in the print substance formulation to determine the color amount. For example, the amount of black print substance is multiplied by (⅓) and added to the amounts of the process color print substances because the cost of the black print substance is approximately one-third the cost of print substances for the process colors.

The threshold value can be based on a cost. In one example, the threshold value can be a selected cost. In another example, the threshold value can be a cost exceeding a selected amount of color amounts. For instance, the threshold value can be selected to exceed the costs of selected percent of the nodes in the table. In one example, the cost of each of the print substance formulations is determined, and the threshold value is chosen such that the selected percentage of print substance formulations does not exceed the threshold value. For example, the threshold value can be selected to remove a chosen percentage of the most expense print substance formulations.

FIG. 2 illustrates an example method 200 that can implement method 100 to modulate the amount of print substance used in the print substance formulations of a color table. As in method 100, the color table includes a plurality of nodes, and each node corresponds with a color input in the first color space and provides a print substance formulation in the second color space. The plurality of nodes are arranged, such as indexed, along a vector, such as a color appearance parameter vector, at 202. The color table may include a plurality of vectors. In one example, each vector includes an initial node and an end node. A threshold node is determined for the vector at 204. The threshold node, in one example, can include a color amount that is not outside the threshold value, but any nodes subsequent the threshold node in the vector include color amounts that are outside the threshold value. If the threshold node is not the end node, the print substance formulation for each node subsequent the threshold node is removed and the remaining print substance formulations are rescaled from the initial node to the end node along the vector at 206. For example, the print substance formulation from the threshold node can be provided to the end node, the remaining print substance formulations can be rescaled along nodes of the vector.

A plurality of nodes can be indexed via a vector, such as color appearance parameter vector at 202. A color appearance parameter can include criteria of human color perception such as hue, colorfulness, saturation (also described as intensity or chroma), lightness, and brightness. One particular vector along which a plurality of nodes can be arranged is a hue vector. A single number, or hue angle, can typically represent hue quantitatively, which can correspond with an angular position around a central or neutral point or axis on a color space coordinate diagram such as the h value in the CIE Lab cylindrical representation CIELCh, or L*C*h color space. The L*C*h color space, similar to CIELAB, generally correlates with how the human eye perceives color. The L*C*h color space includes the diagram of the L*a*b* color space but uses cylindrical coordinates instead of rectangular coordinates. In this color space, L* indicates lightness, C* represents chroma, and h is the hue angle. The value of chroma C* is the distance from the lightness axis (L*) and begins at 0 in the center. Hue angle begins at the +a* axis and is expressed in degrees (for instance, 0° is +a*, or red, and 90° is +b, or yellow).

A color table can include nodes corresponding with a hue selected from a plurality of hues. For example the nodes corresponding with a red hue may be arranged along a red hue vector, and the nodes corresponding with a magenta hue may be arranged along a magenta hue vector. A hue angle for each target color produced using the print substance formulations of the color table can be determined, such as via measured with a colorimeter or calculated from a model, and associated with corresponding node during method 200. The target colors may include additional values of color perception parameters, such as chroma or lightness, which can also be measured or otherwise determined and associated with the corresponding node during method 200.

The nodes corresponding with each hue are arranged from the initial node to the end node in the hue vector. In one example, the nodes in each hue vector are arranged, or generally arranged, via increasing color amount. The initial node can include the print substance formulation having the least color amount, or least amount of cost of print substance, of the nodes in the hue vector and the end node can include the print substance formulation having the greatest color amount of the nodes in the hue vector, or the most expensive print substance formulation. In another example, the nodes in the hue vector can be arranged via increasing chroma, which can generally correlate with the color amount. In this example, the color amount for each node in the vector may be inferred rather than calculated for each node. Thus, a hue vector can include a plurality of nodes corresponding with a hue arranged from an initial node to an end node by increasing chroma, decreasing lightness, or other criteria that generally correlates with increasing cost amount of the print substance formulation.

The color amounts of nodes in the vector can be compared against the threshold value to determine a cutoff node of the vector at 204. In one example, the cutoff node is the final, or generally the final, node along the vector having a cost amount not outside the threshold value. In this example, the subsequent node to the cutoff node includes a cost amount outside the threshold value. The relative position of the threshold node within the vector can vary based on the hue, the amount of nodes in the vector, the print substance formulations for each of the node, and the threshold value selected. For example, a cutoff node in a red hue vector may be relatively closer to the initial node than a cutoff node in a magenta vector because the print formulations used to generate target colors in the red hue may include more print substance amounts than the print formulations used to generate target colors in the magenta hue. If the cutoff node is the end node, then no nodes in the vector include a color amount that is outside the threshold value, and none of the print substance formulations of the nodes in the vector are to be replaced with replacement print substance formulations. In this example, method 200 can end, proceed to another vector, or modify the threshold value such that the cutoff node is not the end node. If, however, the cutoff node is not the end node, the print substance formulations for the nodes of the vector are rescaled with replacement print substance formulations at 206.

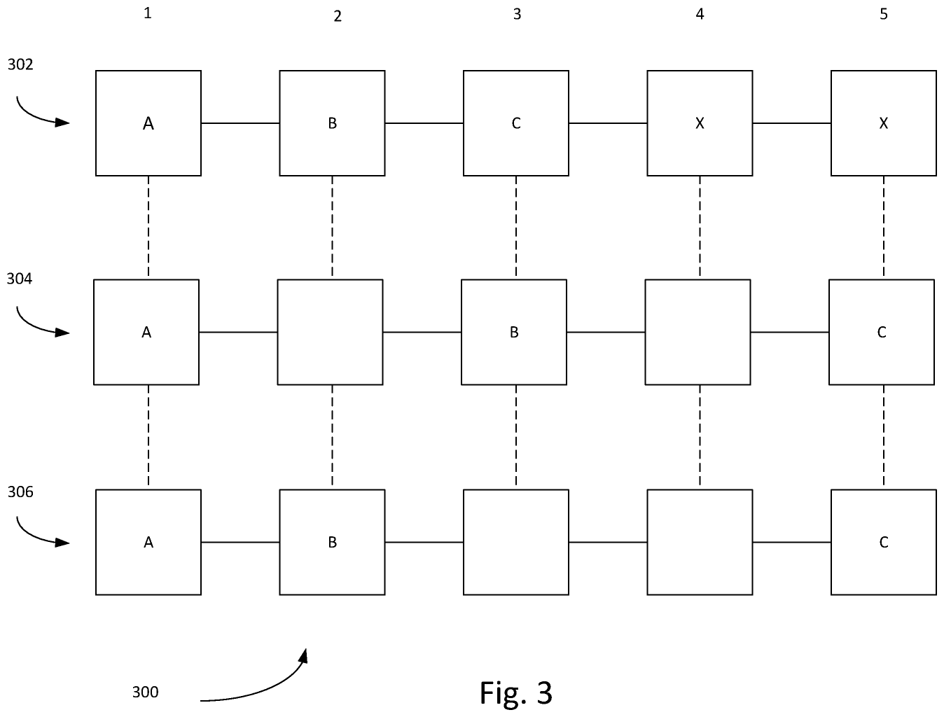

FIG. 3 illustrates an example of rescaling and replacing print substance formulations at 206 for a vector 300 using various models 302, 304, 306. As indicated in the first model 302, vector 300 is indicated having five nodes, such as nodes 1, 2, 3, 4, and 5. Node 1 in the example is the initial node, and node 5 is the end node of the vector 300. Nodes 1-5 each include a print substance formulation that may be used to generate a color amount. For example, node 1 includes print substance formulation A, node 2 includes print substance formulation B, and node 3 includes print substance formulation C. Nodes 1-5 in the example are indexed in order of increasing chroma, which may generally correlate with increasing color amount. In the example, node 3 is the cutoff node for this illustration such that nodes 4 and 5 include color amounts that are outside the threshold value and nodes 1-3 include color amounts that are not outside the threshold value. In the first model 302, print substance formulations for nodes 4 and 5 have been removed.

The second model 304 illustrates one example of rescaling the remaining print substance formulations of nodes 1-3 for vector 300 from the first model 302. The print substance formulation which once corresponded with the end node, or node 5, but was removed in the first model 302, is replaced with the print substance formulation that corresponded with the cutoff node, or node 3 having print substance formulation C. In the example rescaling, print substance formulation B is the replacement print substance formulation for node 3. In this example, nodes 3 and 5 include replacement print substance formulations that are reassigned existing print substance formulations. Print substance formulation A remains the print substance formulation for node 1. Nodes without print substance formulations, such as node 2, which included a reassigned print substance formulation and node 4, which included a removed print substance formulations, are provided with new print substance formulations. In one example, the new print substance formulations can be generated based on the interpolation techniques used to provide print substance formulations for intermediate colors and the new print substance formulations are stored with the color table.

The third model 306 illustrates another example of rescaling the remaining print substance formulations of nodes 1-3 for vector 300 from the first model 302. The print substance formulation which once corresponded with the end node, or node 5, but was removed in the first model 302, is replaced with the print substance formulation that corresponded with the cutoff node, or node 3 having print substance formulation C. In the example rescaling, print substance formulation B remains the print substance formulation for node 2 and print substance formulation A remains the print substance formulation for node 1. Nodes without print substance formulations, such as node 3, which included a reassigned print substance formulation and node 4, which included a removed print substance formulations, are provided with new print substance formulations. In one example, the new print substance formulations can be generated based on the interpolation techniques used to provide print substance formulations for intermediate colors and the new print substance formulations are stored with the color table.

In the illustrated examples of rescaling and replacing print substance formulations at 206, the print substance formulations of the nodes of the vector 300 subjected to method 200 include a color amount that is not outside the threshold value. For example, the nodes of the color table subjected to method 200 include a color amount that does not exceed the threshold value. In addition to using interpolation techniques to provide print substance formulations for nodes having removed or reassigned print substance formulations at 206, a smoothing function can be applied to the print substance formulations of nodes of the vector, including nodes between the initial node and the end node, to provide for smooth transition of the color perception parameter, such as chroma, used to index the nodes.

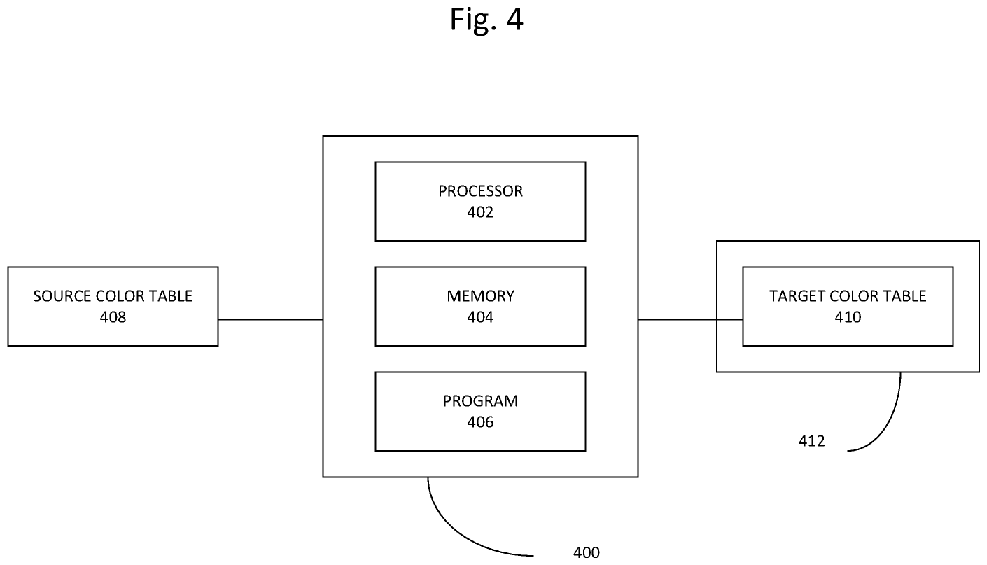

FIG. 4 illustrates an example system 400 including a processor 402 and memory 404 and program 406 to implement example methods 100 and 200. System 400 receives the source color table 408 to modulate and generate the target color table 410 on a memory device 412. Source color table 408 includes a plurality of nodes having print substance formulations stored on a memory device. Memory device 412 can be included with a printing device or on a consumable product for use with the printing device such as a printer cartridge. In one example, system 400 can be implemented with a computing device. Program 406 can be implemented as a set of processor-executable instructions stored on a non-transitory computer readable medium such as memory 404. Computer readable media, computer storage media, memory, or memory device may be implemented to include a volatile computer storage media, nonvolatile computer storage media, or as any suitable method or technology for storage of information such as computer readable instructions, data structures, program modules or other data. A propagating signal by itself does not qualify as computer readable media, computer readable storage media, memory, or a memory device.

System 400 is configured to receive the source color table 408 having nodes including print substance formulations on a memory device. The system 400 can receive additional data or resources regarding the nodes, such as data structures including hue angles, chroma information, color amounts, and threshold values or resources to determine color amounts and threshold values and interpolative techniques that may be used to implement methods 100, 200. In one example, system 400 can generate a bitstream to be stored on memory device 412 as the target color table 410.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
receiving a color table having a plurality of nodes, each node corresponding with a color input in a first color space and providing a print substance formulation in a second color space;
determining whether a color amount of a set of nodes of the plurality of nodes is outside of a threshold value based on the print substance formulation; and
replacing the print substance formulation for each node for which the color amount is outside the threshold value with a replacement print substance formulation having color amount that is within the threshold value.

2. The method of claim 1 comprising generating a target color table having the plurality of nodes, the plurality of nodes of the target color table corresponding with a color input in the first color space and providing a print substance formulation in the second color space having a color amount within the threshold value.

3. The method of claim 1 wherein the color amount is based on a cost of the print substance formulation.

4. The method of claim 3 wherein the threshold value is based on a cost.

5. The method of claim 1 wherein a node outside the threshold value exceeds the threshold value.

6. The method of claim 1 wherein the plurality of nodes are included in a vector having an initial node and an end node.

7. The method of claim 6 wherein determining whether a color amount based on the print substance formulation is outside of a threshold value includes determining a threshold node on the vector in which the threshold node includes threshold print substance formulation that is within the threshold value.

8. The method of claim 7 wherein replacing the print substance formulation for each node for which the color amount is outside the threshold value includes reassigning the threshold print substance formulation to the end node.

9. The method of claim 8 wherein the vector is a hue vector.

10. The method of claim 9 comprising arranging the plurality of nodes along the hue vector via increasing amount of chroma.

11. A system, comprising:
a memory to store a set of instructions; and
a processor to execute the set of instructions to:
receive a color table having a plurality of nodes, wherein each node corresponds with a color input in a first color space and provides a print substance formulation in a second color space;
determine whether a color amount of a set of nodes of the plurality of nodes is outside of a threshold value based on the color substance formulation; and
replace a subset of nodes from the color table for which the color amount for the node is outside a threshold value with a replacement print substance formulation having a color amount that is within the threshold value.

12. The system of claim 11 wherein received color table is a source color table and the replacement print substance formulation is provided to a target color table stored on a memory device.

13. The system of claim 12 wherein the memory device is operably coupled to a printing device.

14. A non-transitory computer readable medium to store computer executable instructions to control a processor to:
receive a color table having a plurality of nodes, wherein each node corresponds with a color input in a first color space and provides a print substance formulation in a second color space;
determine whether a color amount of a set of nodes of the plurality of nodes is outside of a threshold value based on the color substance formulation; and
replace a subset of nodes from the color table for which the color amount for the node is outside a threshold value with a replacement print substance formulation having color amount that is within the threshold value.

15. The non-transitory computer readable medium of claim 14 wherein the plurality of nodes are included on a color perception parameter vector arranged in order of color amount.
